(19) United States
(12) Patent Application Publication
(10) Pub. No.: US 2018/0115710 A1
(43) Pub. Date: Apr. 26, 2018

(54) Apparatus and Method for Adjusting an Image in Response to Flash Driver Output Current

(71) Applicant: Motorola Mobility LLC, Chicago, IL (US)

(72) Inventors: Robert Johnson, Lake Zurich, IL (US); Richard Koss, Oak Creek, IL (US)

(73) Assignee: Motorola Mobility LLC, Chicago, IL (US)

(21) Appl. No.: 15/299,133

(22) Filed: Oct. 20, 2016

(51) Int. Cl. H04N 5/232; H04N 5/235; H04N 5/225; G06T 1/20

(52) U.S. Cl. CPC H04N 5/23241; H04N 5/2351; G06T 1/20; H04N 5/2256; H04N 5/23229

(57) ABSTRACT

A disclosed apparatus includes an image sensor, an LED flash driver, and image adjustment logic, operatively coupled to an LED flash driver. The image adjustment logic is operative to detect a flash driving current level produced by the LED flash driver and to adjust an image captured using the image sensor, in response to the flash driving current level. In one embodiment, the image adjustment logic may access a lookup table to obtain an image adjustment corresponding to a detected flash driving current level. The image adjustment logic is operative to adjust the image processing pipeline, the image sensor, or both, in response to the flash driving current level.

### FIELD OF THE DISCLOSURE

The present disclosure relates generally to digital cameras and more particularly to flash drivers and imagers.

### BACKGROUND

The flash component of a digital camera draws a larger amount of battery current than other components. When a digital camera is integrated into a device such as a mobile telephone, the battery level may be diminished due to other operations of the device, prior to operation of the flash component. If the battery level is too low to support the current draw required for flash component operation, the device may turn off due to low battery power. This may also occur in stand-alone digital cameras (i.e. digital cameras that are not incorporated into mobile telephones). Manufacturers of high-current flash LED drivers have attempted to solve the problem of device shutdown by incorporating a current adjustment feature into the LED drivers. For example, some flash LED drivers include an input voltage monitor that reduces the flash current in order to maintain the input voltage at a given level. Unfortunately, reduction in flash current has an adverse impact on image quality.

### BRIEF DESCRIPTION OF THE DRAWINGS

FIG. 1 is a block diagram of an apparatus with image adjusting logic in accordance with an embodiment.

FIG. 2 is a flow chart of a method of operation in accordance with various embodiments.

FIG. 3 is a flow chart of a method of operation in accordance with various embodiments.

FIG. 4 is a flow chart of a method of operation in accordance with an embodiment.

FIG. 5 is a flow chart of a method of operation in accordance with an embodiment.

### DETAILED DESCRIPTION

Briefly, the disclosed embodiments provide image adjustment logic that is operative to adjust an image in response to a flash driving current level produced by an LED flash driver. A lookup table with data related to various flash driving current levels may be used to make the adjustment. One disclosed apparatus includes an image sensor, an LED flash driver, and image adjustment logic. The image adjustment logic is operatively coupled to the LED flash driver, and is operative to detect a flash driving current level produced by the LED flash driver. The image adjustment logic adjusts an image captured using the image sensor, in response to the flash driving current level.

In one embodiment, an image processing pipeline is operatively coupled to the image sensor and to the image adjustment logic. The image adjustment logic is operative to adjust the image by adjusting the image processing pipeline and/or the image sensor. The embodiments may include a lookup table stored in non-volatile, non-transitory memory. The lookup table includes image adjustments corresponding to flash driving current level entries. The image adjustment logic may perform a table lookup operation to obtain image adjustments for a detected flash driving current level. In some embodiments, the image adjustment logic may also reprogram the LED flash driver to use a flash driving current level corresponding to a lookup table value, so that the associated image adjustments may be applied. Put another way, when the LED flash driver reduces its output current level in a low battery situation, the image adjustment logic is operative to normalize the LED flash driver's flash driving current level to a lookup table value. In some embodiments, the image adjustment logic is operative to execute a flash test pulse using the flash LED driver, and to detect the flash driving current level produced in response to the flash test pulse. If the test shows that the flash LED driver is producing a reduced flash driving current level, then the image adjustment logic can reprogram the flash LED driver such that the flash driving current level matches a lookup table entry.

Another disclosed apparatus includes an image sensor, an LED flash driver, and a processor. The processor is operatively coupled to the image sensor and to the LED flash driver, and is operative to detect a flash driving current level produced by the LED flash driver and adjust an image captured using the image sensor, in response to the flash driving current level. The apparatus may include the lookup table stored in non-volatile, non-transitory memory.

In some embodiments, the processor may access the non-volatile, non-transitory memory to obtain an image adjustment corresponding to the detected flash driving current level. The processor is also operative to adjust an image processing pipeline and/or an image sensor using the image adjustment. In some embodiments, the processor may also be operative to execute a flash test pulse using the flash LED driver to determine if the flash LED driver is producing a reduced flash driving current level. When the flash LED driver produces a reduced flash driving current level, the processor is operative to reprogram the flash LED driver such that the flash driving current level matches a lookup table entry.

In one embodiment, the apparatus may include a graphics processing unit (GPU) that is operatively coupled to the image sensor and to the processor. The processor is operative to send control signals to the GPU to adjust the image processing pipeline executed by the GPU.

The present disclosure also provides methods of operation of the various disclosed apparatuses. One example method includes detecting a flash driving current level produced by a LED flash driver and adjusting an image in response to the flash driving current level. The method may further include adjusting the image by adjusting an image processing pipeline and/or an image sensor.

In some embodiments, the method may include accessing a lookup table stored in non-volatile, non-transitory memory, obtaining the image adjustment corresponding to the detected flash driving current level, and adjusting the image processing pipeline, and/or the image sensor, using the image adjustment.

In some embodiments, the method may include executing a flash test pulse using the flash LED driver and detecting a flash driving current level produced by the LED flash driver in response to the flash test pulse. The method may further include reprogramming the flash LED driver such that the flash driving current level matches a flash driving current level entry in the lookup table. In some embodiments, the method may include adjusting an image stored in a non-volatile, non-transitory memory using an adjustment corresponding to the flash driving current level used to capture the image.

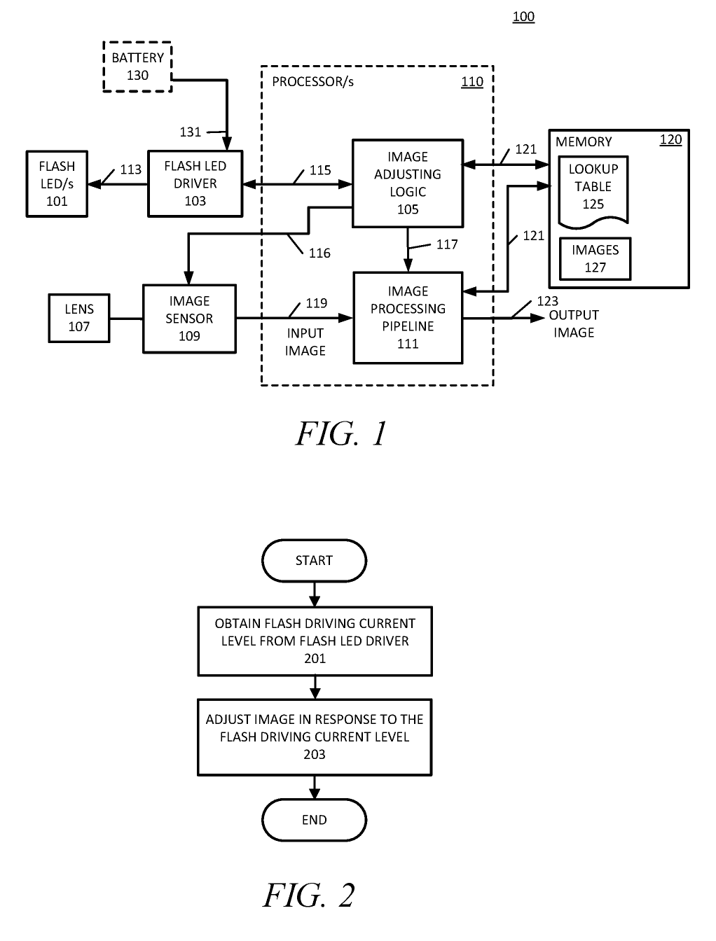

Turning now to the drawings wherein like numerals represent like components, FIG. 1 is a block diagram of an example apparatus 100 with image adjusting logic 105 in accordance with an embodiment. The apparatus 100 includes a lens 107 and an image sensor 109, which is operatively coupled to an image processing pipeline 111. The image sensor 109 is operative to provide an input image 119 to the image processing pipeline 111. The image processing pipeline 111 is operative to make various adjustments to the input image 119 to produce a corresponding output image 123. The output image 123 may be displayed on a display of the apparatus 100, or stored in non-volatile, non-transitory memory 120 using a memory interface 121. The image sensor 109 may be, for example, a charge-coupled device (CCD), an active-pixel sensor (APS) or any other appropriate image sensor. The apparatus 100 may be included in a digital camera, or may be included with a digital camera that is integrated into a mobile phone, laptop computer, tablet, or some other device, etc.

The image adjusting logic 105 is operatively coupled to a flash LED driver 103 by an interface 115, to the image processing pipeline 111, and to the non-volatile, non-transitory memory 120 via the memory interface 121. Operative coupling of the components of apparatus 100 may be implemented using one or more internal communication busses or other appropriate connectivity. The flash LED driver 103 battery monitor input 131 is operatively coupled to the battery 130. In some embodiments, the battery 130 is removable and replaceable. The flash LED driver 103 is operative to monitor the battery 130 and to provide battery charge information to the image adjusting logic 105 over the interface 115.

The flash LED driver 103 is operative to produce a flash driving current 113 to drive one or more flash LEDs 101. The flash LED driver 103 is also operative to control the amount of current and voltage supplied to the flash LEDs 101. More particularly, the flash LED driver 103 includes a feature for reducing the flash driving current 113 supplied to the flash LEDs 101 under low battery power conditions so that the sudden current draw from the flash LED driver 103 does not cause inadvertent shutdown of the apparatus 100. Consequently, the reduction in current supplied to the flash LEDs 101 proportionately reduces the amount of emitted visible light used to capture an image.

In one embodiment, the image adjusting logic 105 is operative to communicate with the flash LED driver 103 over the interface 115 to determine the level of the flash driving current 113 produced by the flash LED driver 103, and to adjust an input image 119 accordingly to compensate for the change in light emission from the flash LEDs 101 given the reduced driving current. The image adjusting logic 105 may adjust the input image 119 by adjusting the image processing pipeline 111 using predetermined adjustment values that correspond to various flash driving current values. In some embodiments, the predetermined adjustment values are stored in a lookup table 125.

The lookup table 125 may be integrated into the image adjusting logic 105, or may be stored in the non-volatile, non-transitory memory 120. In some embodiments, the non-volatile, non-transitory memory 120 may be a separate memory component, operatively coupled to the image adjusting logic 105 by the memory interface 121 over the internal communication buses. However in other embodiments, the memory 120 may be integrated into the image adjusting logic 105 or may be operatively coupled in a System-on-a-chip (SoC) configuration.

The lookup table 125 contains image processing pipeline adjustment entries corresponding to flash driving current values that have been determined during a test procedure using the flash LED driver 103 and flash LEDs 101. The lookup table 125 may vary for different models of flash LED driver 103, flash LEDs 101, image sensor 109 or for combinations. In other words, each model of flash LED driver 103, each model of flash LEDs 101, and each model of image sensor 109 may require a different lookup table because the amount of light emitted for various current settings may differ between models. For the image sensor 109, there may be limitations to the range of certain settings for different models.

Therefore in some embodiments, the image adjusting logic 105 obtains a flash driving current 113 level and compares it to flash driving current values in the lookup table 125. In other words, the image adjusting logic 105 performs a table lookup operation. If a match is found, then the image adjusting logic 105 retrieves the corresponding image processing pipeline adjustment values and adjusts the image processing pipeline 111 accordingly. The image processing pipeline adjustments may include, but are not limited to, color balance, white balance, light gains, exposure, black level subtraction, lens shading correction, demosaic, color correction matrix, global tone map, gamma LUT, color saturation, noise reduction, sharpening, etc. The image adjusting logic 105 is also operative to control the flash LED driver 103 over the interface 115 by sending programming commands to adjust the level of the flash driving current 113. This capability enables the image adjusting logic 105 to normalize the flash driving current 113 to a lookup table 125 value so that the corresponding image processing pipeline adjustments can be used. In some embodiments, the interface 115 is an I²C interface. The image adjusting logic 105 is also operative to control the image sensor 109 over a control interface to send image adjustments 116 to control, for example, electronic shutter speed or other settings, etc.

The image adjusting logic 105 and the image processing pipeline 111 may be implemented in various ways in the embodiments. For example, in one example embodiment, the image adjusting logic 105 and the image processing pipeline 111 may be implemented together as executable instructions executed by the one or more processors 110. In other embodiments, either the image adjusting logic 105, the image processing pipeline 111, or both may be implemented as hardware or as a combination of hardware and software/firmware. In embodiments in which one or more of these components is implemented as software, or partially in software/firmware, the executable instructions may be stored in the operatively coupled, non-volatile, non-transitory memory 120, that may be accessed by the one or more processors 110 as needed. The memory 120 may be operatively coupled to the one or more processors 110, may be integrated therewith, or may be some combination of operatively coupled memory and integrated memory.

It is to be understood that the image adjusting logic 105 may be implemented as software or firmware (or a combination of software and firmware) executing on one or more processors, or using an ASIC (application-specific-integrated-circuit), DSP (digital signal processors), hardwired circuitry (logic circuitry), state machines, an FPGA (field programmable gate array) or combinations thereof. Therefore, the example apparatus 100 illustrated in FIG. 1 and described herein provides an example embodiment and is not to be construed as a limitation on the various other possible implementations that may be used in accordance with the various embodiments.

In one example embodiment, the image adjusting logic 105 may be a single component or may be implemented as executable instructions run on a GPU (graphics processing unit) along with the image processing pipeline 111. In another example embodiment, the image adjusting logic 105 may be implemented using an ASIC or an FPGA. In another example, the image adjusting logic 105 may be a combination of hardware and software or firmware executed by a processor, etc. and may communicate with a GPU in an SoC configuration. These example embodiments and other embodiments are contemplated by the present disclosure.

The flowchart of FIG. 2 shows a method of operation of image adjusting logic 105 in accordance with the various embodiments. The method of operation begins and in operation block 201, the image adjusting logic 105 obtains the flash driving current 113 level from the flash LED driver 103. In some embodiments, the image adjusting logic 105 may obtain the flash driving current level over the interface 115 from the flash LED driver 103. The interface 115 may be an I²C interface in some embodiments. In operation block 203, the image adjusting logic 105 adjusts the input image 119 in response to the flash driving current 113 level. For example, the image adjusting logic 105 sends image adjustments 117 to the image processing pipeline 111, or may send image adjustments 116 to the image sensor 109 or may do both in some embodiments.

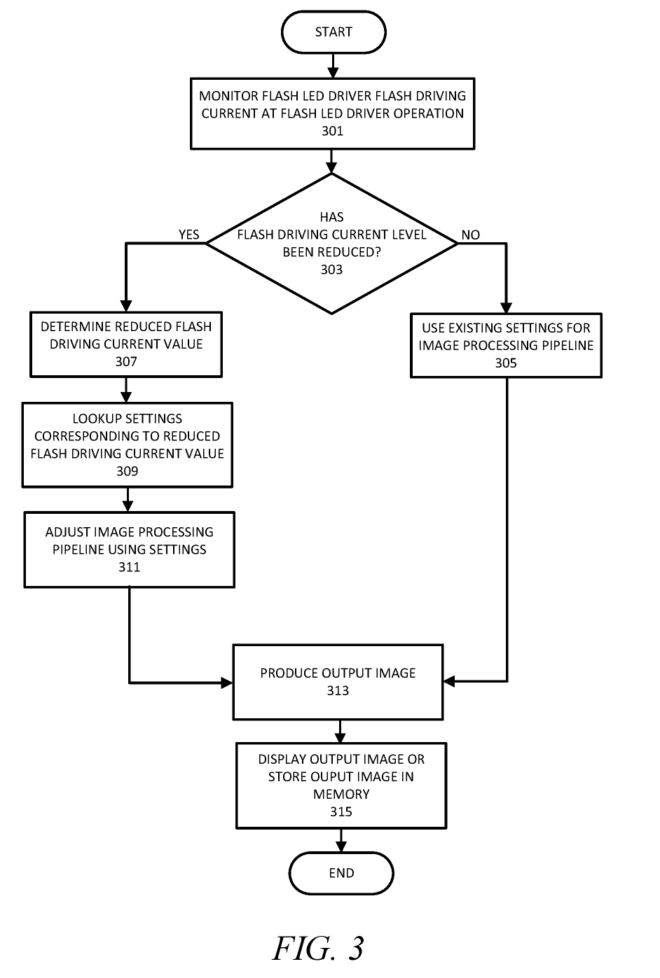

FIG. 3 is a flow chart of another method of operation in accordance with various embodiments. The method of operation begins and in operation block 301, the image adjusting logic 105 monitors the flash driving current 113 produced by the flash LED driver 103. The image adjusting logic 105 may accomplish this by monitoring the flash LED driver 103 operations over the interface 115. For example, if the flash LED driver 103 adjusts the value of the flash driving current 113 level, a parameter may be obtained over the interface 115 that indicates the setting level. In decision block 303, the image adjusting logic 105 determines whether the flash driving current 113 has been reduced. If not, then the image adjusting logic 105 does not take any action and in operation block 305 the image processing pipeline 111 uses existing settings for the input image 119. In operation block 313, the image processing pipeline 111 produces the output image 123, and in operation block 315 the apparatus 100 may display the output image 123, may store the output image 123 in memory 120 as one of the stored images 127, or may do both. The method of operation then terminates as shown.

However if the flash driving current 113 level has been reduced in decision block 303, then in operation block 307 the image adjusting logic 105 will determine the reduced flash driving current 113 value. In operation block 309, the image adjusting logic 105 will lookup image adjustment settings corresponding to the reduced flash driving current 113 value. In operation block 311, the image adjusting logic 105 will send the image adjustments 117 to the image processing pipeline 111 and/or image adjustments 116 to the image sensor 109. In operation block 313, the image processing pipeline 111 will then proceed to produce the output image 123. In operation block 315, the apparatus 100 may display the output image 123, may store the output image 123 in memory 120 as one of the stored images 127, or do both. The method of operation then terminates as shown.

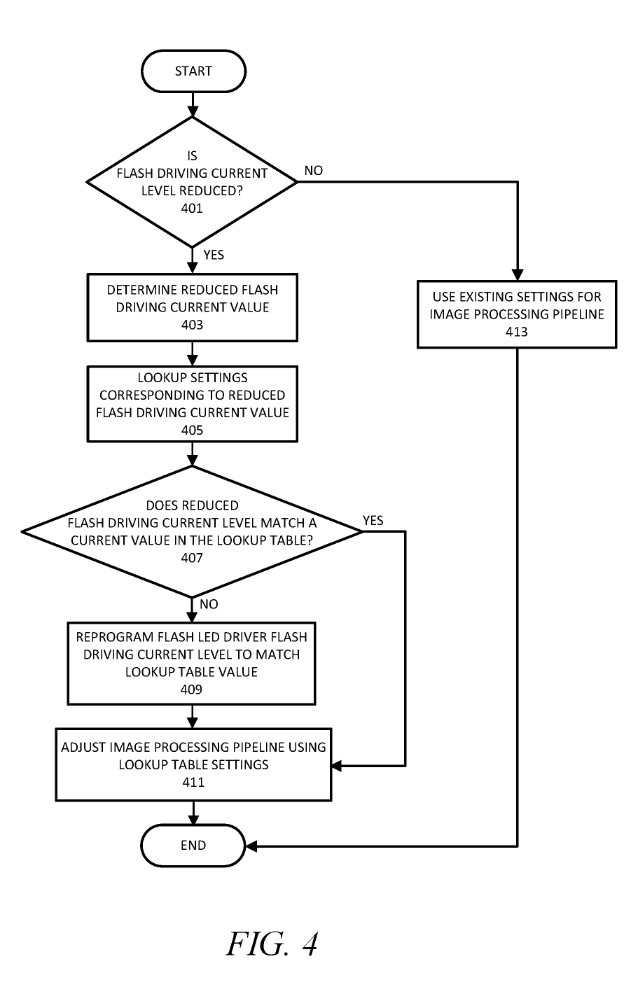

FIG. 4 is a flow chart of another method of operation in accordance with an embodiment. The method of operation begins and in decision block 401, the image adjusting logic 105 monitors the interface 115 and determines whether the flash driving current 113 level has been reduced. If not, then the image adjusting logic 105 takes no action and in operation block 413 the image processing pipeline 111 uses existing settings for the input image 119. The method of operation then terminates as shown.

However if the image adjusting logic 105 determines that the flash driving current 113 level has been reduced in decision block 401, then in operation block 403 the image adjusting logic 105 determines the reduced flash driving current 113 value. In operation block 405, the image adjusting logic 105 performs a table lookup operation and will look up settings corresponding to the reduced flash driving current 113 value.

In decision block 407, the image adjusting logic 105 will determine whether the reduced flash driving current 113 level matches a current value in the lookup table 125. If a matching value is found in decision block 407, then the method of operation proceeds to operation block 411 and the image adjusting logic 105 will obtain image adjustments from the lookup table 125 and will send image adjustments 117 to the image processing pipeline 111, and/or send image adjustments 116 to the image sensor 109. The method of operation then terminates as shown. However, if in decision block 407 there is no matching current value in the lookup table 125 for the flash driving current 113 level, then in operation block 409 the image adjusting logic 105 will reprogram the flash LED driver 103 such that the flash driving current 113 level matches a value in the lookup table 125. In other words, the image adjusting logic 105 normalizes the flash driving current 113 to a lookup table 125 value such that the corresponding image adjustments from the lookup table 125 may be applied to the input image 119. In operation block 411, the image adjusting logic 105 sends the image adjustments 117 to the image processing pipeline 111, and/or image adjustments 116 to the image sensor 109, to adjust the input image 119 using the lookup table 125 image adjustment settings that correspond to the normalized flash driving current 113. The method of operation then terminates as shown.

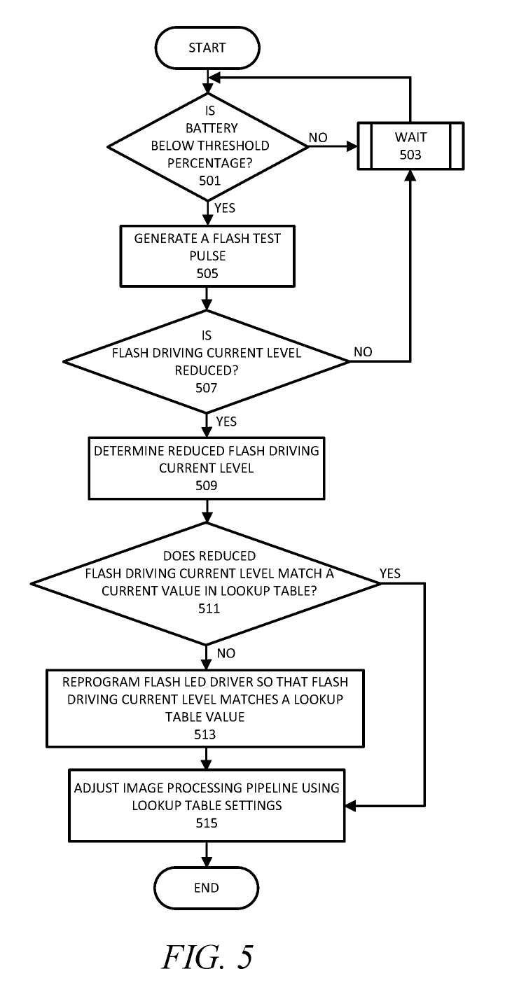

FIG. 5 is a flow chart of another method of operation in accordance with an embodiment. The method of operation begins, and in decision block 501, the image adjusting logic 105 monitors battery 130 power via the interface 115 from flash LED driver 103, and determines if the battery 130 power is below a threshold percentage. In one example, the image adjusting logic 105 may determine whether the battery 130 is below 10% of its full charge. In another example, the image adjusting logic 105 may determine whether the battery 130 is below 50% of its full charge. Any percentage charge may be used as the battery threshold percentage in decision block 501 in accordance with the various embodiments. In some embodiments, the image adjusting logic 105 may obtain battery 130 charge information from the flash LED driver 103 in order to make the determination of the battery 130 percentage charge.

If in decision block 501 the battery 130 charge is not below the threshold percentage, then the method of operation proceeds to operation block 503 and waits until the battery discharges below the threshold percentage. However, if the battery 130 charge is below the threshold percentage in decision block 501, then in operation block 505 the image adjusting logic 105 controls the flash LED driver 103 to generate a flash test pulse. The image adjusting logic 105 may send a programming command over the interface 115 to the flash LED driver 103 to generate the test pulse and produce a corresponding flash driving current 113 to drive the flash LEDs 101. The image adjusting logic 105 will then observe the flash driving current 113 level produced by the flash LED driver 103. Therefore in decision block 507, the image adjusting logic 105 will determine whether the flash driving current 113 level has been reduced by the flash LED driver 103. If not, then the method of operation proceeds to operation block 503 and waits again until the battery 130 charge is below the threshold percentage. In other words the image adjusting logic 105 monitors to determine if the flash LED driver 103 has implemented a current reduction feature when the battery 130 begins to discharge.

If in decision block 507 the image adjusting logic 105 determines that the flash driving current 113 level has been reduced by the flash LED driver 103, then the method of operation proceeds to operation block 509. In operation block 509, the image adjusting logic 105 determines the reduced flash driving current 113 level. In decision block 511, the image adjusting logic 105 performs a lookup table 125 operation to determine if the reduced flash driving current 113 level matches a flash driving current value in the lookup table 125. If a match is found, then in operation block 515 the image adjusting logic 105 retrieves the corresponding settings from the lookup table 125 and provides those settings as image adjustments 117 to the image processing pipeline 111, and/or image adjustments 116 to the image sensor 109. The method of operation then terminates as shown.

However, if in decision block 511 the image adjusting logic 105 is not able to find a match for the reduced flash driving current 113 level within the lookup table 125, then in operation block 513 the image adjusting logic 105 will reprogram the flash LED driver 103 so that the flash driving current 113 level matches a lookup table 125 value. In operation block 515, the image adjusting logic 105 will send the lookup table 125 values corresponding to the normalized flash driving current 113 level as image adjustments 117 to the image processing pipeline 111, and/or image adjustments 116 to the image sensor 109, to adjust the input image 119. The method of operation then terminates as shown.

The image adjusting logic 105 may perform the flash driving current 113 normalization to the lookup table 125 using various approaches. In one example approach, the image adjusting logic 105 may select the next lowest flash driving current value in the lookup table 125 that is lower than the observed flash driving current 113 level. However, in some situations, it may be that the next lowest flash driving current value in the lookup table 125 is a larger difference from the observed flash driving current 113 level then the next higher flash driving current value in the lookup table 125. In that case, the image adjusting logic 105 may use the approach of selecting the lookup table 125 value that has the smallest percentage difference from the observed flash driving current 113 level. In some embodiments where the image adjusting logic 105 uses the smallest percentage difference approach, a threshold may also be set as an upper bound on the highest flash driving current level that can be set. For example, an upper threshold may prevent the image adjusting logic 105 from selecting a lookup table 125 value that is greater than 10% of the observed, reduced flash driving current 113 level. In that case, if the lookup table 125 value is above the 10% threshold, then the image adjusting logic 105 would select the next lower lookup table 125 value that is lower than the observed flash driving current 113 level (even if the lower value was a larger percentage difference). This approach would prevent the image adjusting logic 105 from inadvertently setting a flash driving current level that may cause the apparatus 100 battery 130 to drain to a point where the apparatus 100 would shut down. In other words, the image adjusting logic 105 would have a normalization safety feature to prevent it from reprogramming the flash LED driver 103 to produce a flash driving current 113 that is too high above the observed settings produced by the flash LED driver 103 current reduction feature. In other words, the image adjusting logic 105 will attempt to find a lookup table 125 value during normalization that is as close to the flash LED driver 103 reduced current setting as possible.

It is to be understood that while FIG. 1 shows an input image 119 being processed by the image processing pipeline 111 to produce an output image 123, in some embodiments the image adjusting logic 105 and the image processing pipeline 111 may perform operations on images 127 that are stored in the memory 120. For example, the one or more processors 110 may capture a raw image using the image sensor 109 and may store the raw image in memory 120 as one of the images 127. The image adjusting logic 105 may store the flash driving current 113 level produced by the flash LED driver 103 at the time the raw image was captured by the image sensor 109. In that case the image adjusting logic 105 may be used to subsequently adjust one of the images 127 stored in memory 120 using image adjustments 117 obtained from the lookup table 125 retroactively as an image retouching operation. In this case, because the image adjusting logic 105 cannot normalize the flash driving current 113 level that was used to capture the stored image, the image adjusting logic 105 can use the closest corresponding value from the lookup table 125 to obtain the appropriate image adjustments 117.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. An apparatus comprising:
an image sensor;
an LED flash driver;
image adjustment logic, operatively coupled to the LED flash driver, the image adjustment logic operative to:
detect a flash driving current level produced by the LED flash driver; and
adjust an image obtained using the image sensor, in response to the flash driving current level.

2. The apparatus of claim 1, further comprising:
an image processing pipeline, operatively coupled to the image sensor and to the image adjustment logic, wherein the image adjustment logic is operative to adjust an input image by adjusting the image processing pipeline.

3. The apparatus of claim 1, wherein the image adjustment logic is operative to adjust an input image by adjusting the image sensor.

4. The apparatus of claim 1, further comprising:
a lookup table stored in non-volatile, non-transitory memory comprising a plurality of flash driving current level entries, each entry having a corresponding image adjustment.

5. The apparatus of claim 4, wherein the image adjustment logic is further operative to:
access the non-volatile, non-transitory memory to obtain an image adjustment corresponding to the detected flash driving current level; and
adjust the image using the image adjustment.

6. The apparatus of claim 1, wherein the image adjustment logic is further operative to:
execute a flash test pulse using the flash LED driver; and
detect a flash driving current level produced by the LED flash driver in response to the flash test pulse.

7. The apparatus of claim 4, wherein the image adjustment logic is further operative to:
reprogram the flash LED driver such that the flash driving current level matches a flash driving current level entry in the lookup table.

8. The apparatus of claim 1, further comprising:
non-volatile, non-transitory memory, operatively coupled to the image sensor and to the image adjustment logic; and
wherein the image adjustment logic is operative to adjust an image stored in the memory using an adjustment corresponding to the flash driving current level used to capture the image.

9. An apparatus comprising:
an image sensor;
an LED flash driver;
a processor, operatively coupled to the image sensor and to the LED flash driver, the processor operative to:
detect a flash driving current level produced by the LED flash driver; and
adjust an image in response to the flash driving current level.

10. The apparatus of claim 9, further comprising:
a lookup table stored in non-volatile, non-transitory memory comprising a plurality of flash driving current level entries, each entry having a corresponding image adjustment.

11. The apparatus of claim 10, wherein the processor is further operative to:
access the non-volatile, non-transitory memory to obtain an image adjustment corresponding to the detected flash driving current level; and
adjust an image using the image adjustment.

12. The apparatus of claim 9, wherein the processor is further operative to:
execute a flash test pulse using the flash LED driver; and
detect a flash driving current level produced by the LED flash driver in response to the flash test pulse.

13. The apparatus of claim 10, wherein the processor is further operative to:
reprogram the LED flash driver such that the flash driving current level matches a flash driving current level entry in the lookup table.

14. The apparatus of claim 9, further comprising:
a graphics processing unit (GPU) operatively coupled to the processor, and to the image sensor, the GPU operative to execute an image processing pipeline; and
wherein the processor is operative to send control signals to the GPU to adjust the image processing pipeline.

15. A method comprising:
detecting a flash driving current level produced by a LED flash driver; and
adjusting an image in response to the flash driving current level.

16. The method of claim 15, further comprising:
adjusting the image by adjusting an image processing pipeline.

17. The method of claim 15, further comprising:
adjusting the image by adjusting an image sensor.

18. The method of claim 16, further comprising:
accessing a lookup table stored in non-volatile, non-transitory memory comprising a plurality of flash driving current level entries, each entry having a corresponding image processing pipeline adjustment;
obtaining an image processing pipeline adjustment corresponding to the detected flash driving current level; and
adjusting the image processing pipeline using the image processing pipeline adjustment.

19. The method of claim 15, further comprising:
executing a flash test pulse using the flash LED driver; and
detecting a flash driving current level produced by the LED flash driver in response to the flash test pulse.

20. The method of claim 18, further comprising:
reprograming the flash LED driver such that the flash driving current level matches a flash driving current level entry in the lookup table.

21. The method of claim 15, further comprising:
storing the image in non-volatile, non-transitory memory; and
adjusting the stored image using an adjustment corresponding to the flash driving current level used to capture the stored image.
